(19) United States
(12) Patent Application Publication
(10) Pub. No.: US 2008/0210173 A1
(43) Pub. Date: Sep. 4, 2008

(54) ANIMAL LITTER

(75) Inventors: Kevin S. Spittle, Vero Beach, FL (US); James D. Tanner, Northbrook, IL (US)

Correspondence Address: BROOKS KUSHMAN P.C., 1000 TOWN CENTER, TWENTY-SECOND FLOOR, SOUTHFIELD, MI, 48075, US

(73) Assignee: PROFILE PRODUCTS L.L.C., Buffalo Grove, IL (US)

(21) Appl. No.: 12/015,583

(22) Filed: Jan. 17, 2008

Related U.S. Application Data
(60) Provisional application No. 60/885,449, filed on Jan. 18, 2007.

(51) Int. Cl. A01K 29/00; B01J 20/22

(52) U.S. Cl. 119/172; 502/401

(57) ABSTRACT

An animal litter with increased moisture retention and accelerated absorbency, a method of manufacture and method of use for indoor urine and feces disposal. An animal litter with a greater surface area and higher moisture retention intended for animals as small as mice, gerbils and hamsters, as well as larger domestic animals. The animal litter is a paper and wood composition treated with a surfactant, which increases moisture retention four to five times its weight.

### CROSS-REFERENCE TO RELATED APPLICATIONS

This application claims the benefit of U.S. provisional application Ser. No. 60/885,449 filed Jan. 18, 2007.

### BACKGROUND OF THE INVENTION

1. Field of the Invention

The invention relates to an animal litter with increased moisture retention and accelerated absorbency, a method of manufacture and method of use for indoor urine and feces disposal.

2. Background Art

Animal litter is typically used for indoor urine and feces disposal to simulate the natural instincts of animals to excrete in soft soil for easy burial. The litter is generally composed of clay, recycled paper, or silicate-based granular material. A deodorant or fragrance may be added to mask the odor of the urine and feces.

Small animals kept in cages such as mice, hamsters and gerbils require frequent changes of the litter to keep cages clean and sanitary. Laboratory animals also require a non-toxic litter to reduce the effect of the environment on animal testing. Many animal litters are not biodegradable and they are difficult to dispose of by flushing the litter down the toilet. Alternatively, the amount of litter disposed of in landfills leads to an enormous amount of waste that is not biodegradable.

There is a need to produce an animal litter material which is more highly absorbent. Additives have been used to improve moisture retention and increase the time between changes of the animal litter. However, these additives frequently increase the cost of the litter material, and are not always as effective as desired for their intended purpose. There is also a need to have an animal litter that is biodegradable, does not clog toilets and reduces the amount of non-degradable waste in landfills.

### SUMMARY OF THE INVENTION

The present invention provides a composition for an animal litter with a greater surface area, composed of paper and wood. This composition is treated with a surfactant which provides a composition with the ability to retain moisture in amounts of up to approximately four to five times its weight. The composition may also contain additional ingredients for odor and moisture control, dyes, pigments, and the like. It is further an object of the invention to provide a method of manufacturing the animal litter, and processes for use as litter in collecting urine and/or feces of animals.

### DETAILED DESCRIPTION OF THE PREFERRED EMBODIMENT

In a preferred embodiment of an animal litter, the product comprises finely-divided paper, and/or finely-divided wood, and a surfactant. The finely-divided paper and wood are liquid absorbent in and of themselves. The addition of a surfactant increases the liquid retention properties of the paper and wood particles, and also speeds liquid absorption. It can increase the absorption approximately four to five times the weight of the animal litter.

In one variation of the preferred embodiment an animal litter includes: approximately 60% to 85% by weight of finely-divided paper, more preferably 70% to 85% and approximately 15% to 40% by weight of finely-divided wood, more preferably 15% to 30%, approximately 0.1% to 1.0% of a deodorizer, preferably 0.5% by weight and approximately 0.1% to 0.5% by weight of a surfactant, the percentages totaling 100% by weight. A highly preferred embodiment utilizes approximately 80%+/−2% by weight of finely-divided paper, approximately 20%+/−2% by weight of finely-divided wood, approximately 0.5% by weight of the deodorizer, sodium bicarbonate, and approximately 0.2% by weight of the surfactant, polyoxyalkylene glycol, to prepare an animal litter with high moisture retention properties. The pH of the resulting animal litter should be adjusted to be slightly acidic between (pH 3.5 and 5.5) to control the amount of ammonia gas released from urine absorbed by the animal litter. Choice of weak acids to adjust the pH must be balanced with compatibility with the surfactant and deodorant utilized in the animal litter. In the inventive compositions, each integral percentage of each ingredient between the broadest end points of that ingredient is considered as fully disclosed herein, and part of the disclosed invention.

The method of manufacturing described produces a softer animal litter than those containing coarser materials such as clay. Research has shown that smaller animals prefer finely granulated litters, presumably because they have a softer feel. Larger animals such as rats, rabbits and guinea pigs prefer a slightly larger granulated litter. Softer animal litters are also preferred by the laboratory animal management industry for use with automated bedding dispensers.

Additionally, an animal litter composition with an increased rate of absorbency is a preferred factor in reducing the number of litter changes and reduces the amount of animal waste which passes to the bottom of the animal housing unit.

The method of manufacturing is similar to U.S. Pat. No. 6,158,167 for “Mulch Flakes” herein expressly incorporated by reference which are a paper and wood-based material treated with a surfactant and mixed with a liquid to produce a slurry capable of use in hydro-mulching tanks to be sprayed on the ground.

An appropriate concentration of a deodorizer and additional organic or synthetic absorbent materials may be included to control odors and reduce moisture. Such fragrances and deodorants are well known to those skilled in the art. Examples may be found in U.S. Pat. Nos. 5,100,600; 5,888,345; 6,635,344; and 7,163,737, all herein incorporated by reference. In addition, dyes and pigments may be added to produce an aesthetically pleasing color, or a color which may influence an animal's decision to use the litter. Neutralizing substances such as calcium carbonate or magnesium carbonate may also be added.

The surfactants used may be any which promote the wetting of the paper and wood fibers. These surfactants may be anionic, cationic, zwitterionic, or non-ionic. Examples of relatively inexpensive ionic surfactants are the alkylbenzene sulfonates and naphthalene sulfonates. Fatty acid salts may also be useful for this purpose. Preferred for use as surfactants, however, are non-ionic polyether surfactants such as polyoxyethylated, polyoxypropylated, and both polyoxyethylated and polyoxypropylated compounds having active hydrogen atoms. Other alkylene oxides can in principle be used to prepare the preferred surfactants, but are in general more expensive than those prepared from ethylene oxide and/or propylene oxide.

The oxyalkylation may be block, random (heteric), block random, or any distribution which provides the necessary wetting properties. Unless of very low molecular weight (<500 Da), surfactants prepared from higher alkylene oxides such as propylene oxide and butylene oxide have little if any wetting action. Reference may be had to NONIONIC SURFACTANTS, Martin Schick, ed., Marcel Dekker (1987) for suitable wetting action. Examples include: polyoxyethylated aliphatic alcohols, phenol, alkylphenols, glycols, glycerine, etc. Nonylphenol ethoxylates and block polyoxyalkylene polyethers having at least one hydrophobic moiety and one hydrophilic moiety are preferred. In principle, surfactants such as polyoxyalkylene polysiloxane copolymers are also useful, but these tend to be more expensive. Surfactants containing glycosidyl radicals and polyglycosidyl radicals are also suitable.

Tests for suitable surfactants and the amount required are readily made by preparing a surfactant-free litter product, adding the surfactant being tested, neat, as a suspension or dispersion, or dissolved in suitable solvent (preferably water, lower alcohols, acetones, or mixtures thereof), the surfactant-containing litter is dried, and tested as such or after being compressed to a felt-like product. A known weight of water is added and the time to its complete absorption measured. Surfactants with different wetting abilities can easily be compared by this method.

The animal litter of the preferred embodiment for small animals may be produced as follows: Recycled newspapers are shredded and processed through a hammer mill or similar equipment. The resulting paper pieces are next introduced into a finish hammer mill or similar equipment. Additionally, an appropriate amount of sawdust is added to the finish hammer mill. The approximate sizes of the components to be added to the finish hammer mill may include: Paper approximately ¼ to 1½ inches in length, and sawdust passed through a 20-mesh screen. A liquid surfactant, for example, a polyoxyalkylene glycol, and a fragrance or deodorant may be included in the correct proportion to the mixture of solids. The resultant mixture is granulated to produce the animal litter product. The finished product is processed to select the desired finely granulated litter. The various components are predominantly present as an intimate mixture in the granules thus formed. A simple mixture of finely divided paper and wood fiber is not suitable for use as a litter product.

### EXAMPLE

Small Animal Litter finished product meeting the following specifications, utilizing 50 grams of finished product, as measured by a Rotap Sieve Shaker, ASTM E-11 Specification #4, #8, #16, #25, #50 and Pan:

| | |
|---|---|
| 25.72% | greater than 4.75 mm (range: 23% to 26%) |
| 55.90% | 4.75 mm-2.36 mm (range: 53% to 56%) |
| 11.68% | 2.36 mm-1.18 mm (range: 9% to 12%) |
| 2.33% | 1.18 mm-0.71 mm (range: 1% to 3.5%) |
| 1.27% | 0.71 mm-0.30 mm (range: 0.5% to 2%) |
| 0.10% | less than 0.3 mm (range: 0% to 0.5%) |

In a further production embodiment, the animal litter may be granulated into a larger granule for larger animals.

The subject invention is also directed to the use of the animal litter to receive urine and/or feces from animals. The animal litter may be packaged in bulk for laboratory use in automatic bedding dispensers. In the preferred use, the animal litter of the subject invention is usually added to a box or tray, which may be part of the packaging thereof, i.e. prepackaged trays containing a recommended amount of litter. The prepackaged trays may be sold individually or packaged in stacks of several trays. The trays may be of aluminum, paper, plastic, fiberboard, etc., and may come with a releasable adhesively banded cover. The cover may be removed from all edges or from all except a last edge of the tray, and placed beneath the tray. When the litter is to be replaced, the adhesive cover may be replaced and resealed, facilitating transport and disposal.

While an embodiment of the invention has been illustrated and described, it is not intended that the embodiment illustrates and describes all possible forms of the invention. Rather, the words used in the specification are words of description rather than limitation, and it is understood that various changes may be made without departing from the spirit and scope of the invention.

What is claimed is:

1. An animal litter comprising a pelletized composition comprising:
a) a finely divided wood material;
b) a finely divided paper material; and
c) a surfactant.

2. The animal litter of claim 1, further comprising a deodorant to reduce odor.

3. The animal litter of claim 1, further comprising a buffered acid to acidify the pH of the animal litter.

4. The animal litter of claim 1, further comprising a dye, a pigment or mixtures thereof.

5. The animal litter of claim 1, wherein the finely divided wood material is a sawdust.

6. The animal litter of claim 1, wherein the finely divided wood material is a wood shaving.

7. The animal litter of claim 1, wherein the finely divided wood comprises 15% to 40% by weight of dry ingredients.

8. The animal litter of claim 1, wherein the finely divided paper material is less than ¾ inches in length.

9. The animal litter of claim 1, wherein the finely divided paper material is ¾ inches to 1½ inches in length.

10. The animal litter of claim 1, wherein the finely divided paper comprises 60% to 85% by weight of dry ingredients.

11. The animal litter of claim 1, wherein the surfactant is a polyoxyalkylene glycol.

12. The animal litter of claim 1, wherein the surfactant is a non-ionic polyether, a polyoxyethylated compound, a polyoxypropylated compound, and mixtures thereof.

13. An animal litter of claim 1, wherein the surfactant is an ethylene oxide compound, a propylene oxide compound, and mixtures thereof.

14. The animal litter of claim 1, wherein the deodorant is a sodium bicarbonate.

15. A method of manufacturing the animal litter of claim 1, comprising:
a) milling a paper material into finely divided paper;
b) processing a wood material into finely divided wood;
c) combining the finely divided paper and the finely divided wood with a surfactant;
d) optionally, adding a deodorant;
e) optionally, adding a dye, a pigment or mixture thereof;
f) optionally, adjusting the pH;
g) mixing the composition and pelletizing to form granules; and
h) optionally sieving the composition to select granules of a target size range.

16. The method of manufacturing the animal litter of claim 1, further comprising placing said animal litter in a bulk container to facilitate use in an automatic bedding dispenser.

17. The method of manufacturing the animal litter of claim 1, further comprising placing said animal litter in a disposable litter container with a fixedly connected cover for storage prior to use.

18. The method of manufacturing the animal litter of claim 17, further comprising a resealable adhesive cover fixedly connected to the disposable litter container to facilitate sanitary disposal of the animal litter.

19. The method of manufacturing the animal litter of claim 17, wherein the disposable litter container is made of materials selected from the group containing paper, cardboard, fiberboard and plastic.

20. A method of use of the animal litter of claim 1, comprising the steps of:
a) placing the animal litter in an animal cage or a litter box to receive urine and feces from animals;
b) collecting litter containing urine and feces from animal cage or litter box.
